(19) United States
(12) Patent Application Publication
(10) Pub. No.: US 2026/0039553 A1
(43) Pub. Date: Feb. 5, 2026

(54) USING AN OUT OF BAND VIRTUAL SWITCH TO MANAGE DATA PROCESSING UNIT PORTS IN AN OFFLOAD ARCHITECTURE

(71) Applicant: Dell Products L.P., Round Rock, TX (US)

(72) Inventors: Padmanabhan Narayanan, Chennai (IN); Kumarapuram Parameswaran Balasubramanian, Chennai (IN); Chitra Raghavan, Chennai (IN); Parameswaran Krishnamurthy, Chennai (IN); Gunasekaran Tamilarasan, Chennai (IN); Anbalagan Natchimuthu, Chennai (IN); Arul Jeniston Maria Cheladurai, Chennai (IN)

(21) Appl. No.: 18/788,768

(22) Filed: Jul. 30, 2024

(51) Int. Cl. H04L 41/0895; H04L 41/0893; H04L 45/02

(52) U.S. Cl. CPC H04L 41/0895; H04L 41/0893; H04L 45/10; H04L 41/12

(57) ABSTRACT

A method for managing servers, comprising obtaining connectivity information for a plurality of ports and the plurality of switches, wherein each of the ports is a data processing unit (DPU) port, and wherein each of the ports is located on one of a plurality of DPUs on one of a plurality of servers. The method further comprises generating, by a virtual Top Of Rack (ToR) switch (VTS) executing on a management server, a port mapping using the connectivity information, wherein the management server is not directly connected to the plurality of switches, and configuring, using the VTS and the port mapping, a port of the plurality of ports.

### BACKGROUND

In order for servers to communicate, they need to be connected to a network. Connecting a server to a network, or more specifically, a switch in the network, requires an administrator to perform various configuration operations.

### BRIEF DESCRIPTION OF DRAWINGS

FIG. 1.1 shows a system in accordance with one or more embodiments of the invention.

FIG. 1.2 shows a more detailed view of a portion of the server shown in FIG. 1.1 in accordance with one or more embodiments of the invention.

FIG. 2 shows a method for configuring the system shown in FIG. 1.1 in accordance with one or more embodiments of the invention.

FIG. 3 shows a method for using the system shown in FIG. 1.1 in accordance with one or more embodiments of the invention.

FIG. 4 shows a computing system in accordance with one or more embodiments of the invention.

### DETAILED DESCRIPTION

In traditional data center, servers (or more specifically network interface cards on the servers) are connected to top of rack (ToR) switches. The ToR switches are connected to a smaller set of spine switches, which are in turn connected to a smaller set of super spine switches. The spine switches are typically used to aggregate the network traffic from the ToR switches and provide this network traffic to the super spine switches. The super spine switches typically connect the data center to the Internet (or another wide area network). Network administrators are able to manage the network by managing a relatively small number (as compared to the number of servers) of switches.

With the increased prevalence of data processing units (DPUs) in servers, the networking architecture in data centers has changed. Specifically, the functionality of the ToR switches is distributed across the DPUs. As a result, the the DPUs (or more specifically, the ports on the DPUs (also referred to as DPU ports)) are directly connected to the spine switches and the ToR switches are removed (or no longer present) in the network architecture.

This new network architecture has resulted in an increased management overhead (and related higher cognitive load) for network administrators. Specifically, the network administrators now need to configure DPU ports on a per-DPU or on a per-server basis instead of having to only configure the switches. For example, consider a scenario in which there are 16 dual DPU ported servers (i.e., a server with two DPUs with each DPU having two ports) connected to a single 32 port spine switch. In this scenario, =the network administrator would need to configure at least 16 servers. By contrast, if the same 16 servers are used in a traditional network architecture that included a ToR switch with 32 ports (where the 32 ports are connected to the 16 servers), then the network administrator would only need to configure the single ToR switch.

Embodiments of the invention provide a system and method for decreasing the management overhead that results from using servers with DPUs. In particular, embodiments of the invention introduce an out-of-band (OOB) virtual ToR switch (VTS) (or multiple VTSes), where the VTS(es) includes virtual interfaces that are mapped to the DPU ports. The network administrator is then able to issue configuration commands to the virtual ToR switch (as if it were a physical virtual ToR switch(es)). The virtual ToR switch(es), using the aforementioned mapping, converts the configuration commands in to corresponding DPU configuration commands. This is done in a manner that is transparent to the network administrator. Thus, the network administrator is able to implement data centers with the new network architecture without incurring the aforementioned additional management overhead.

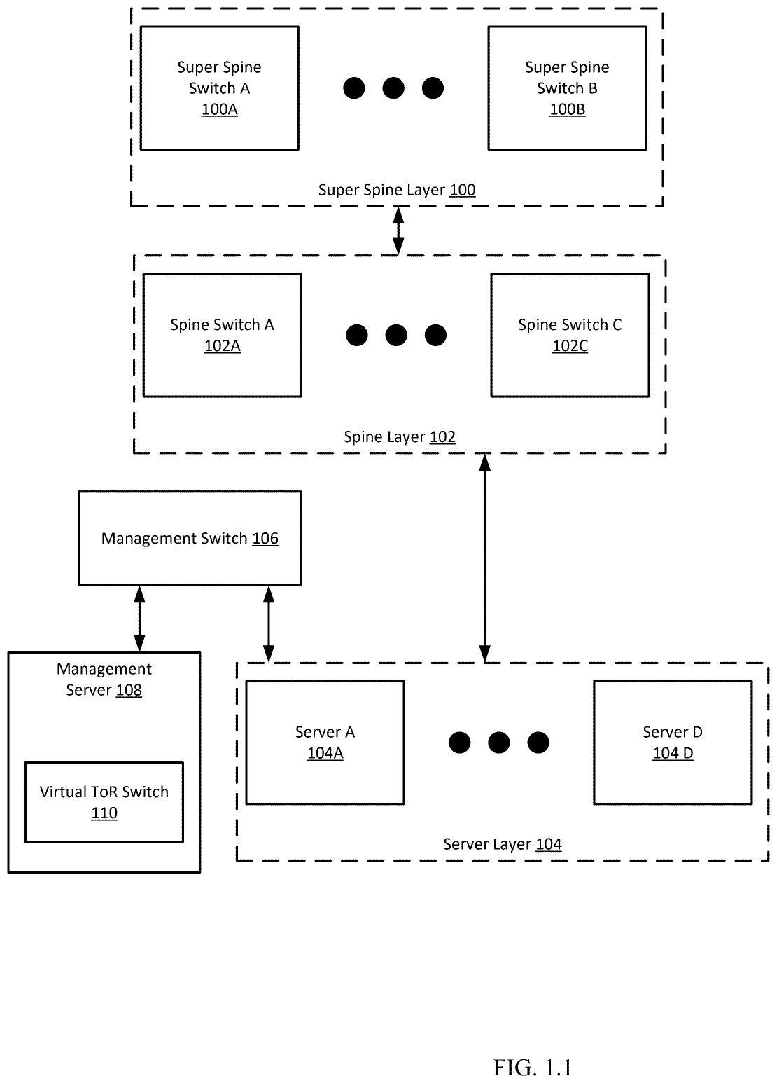

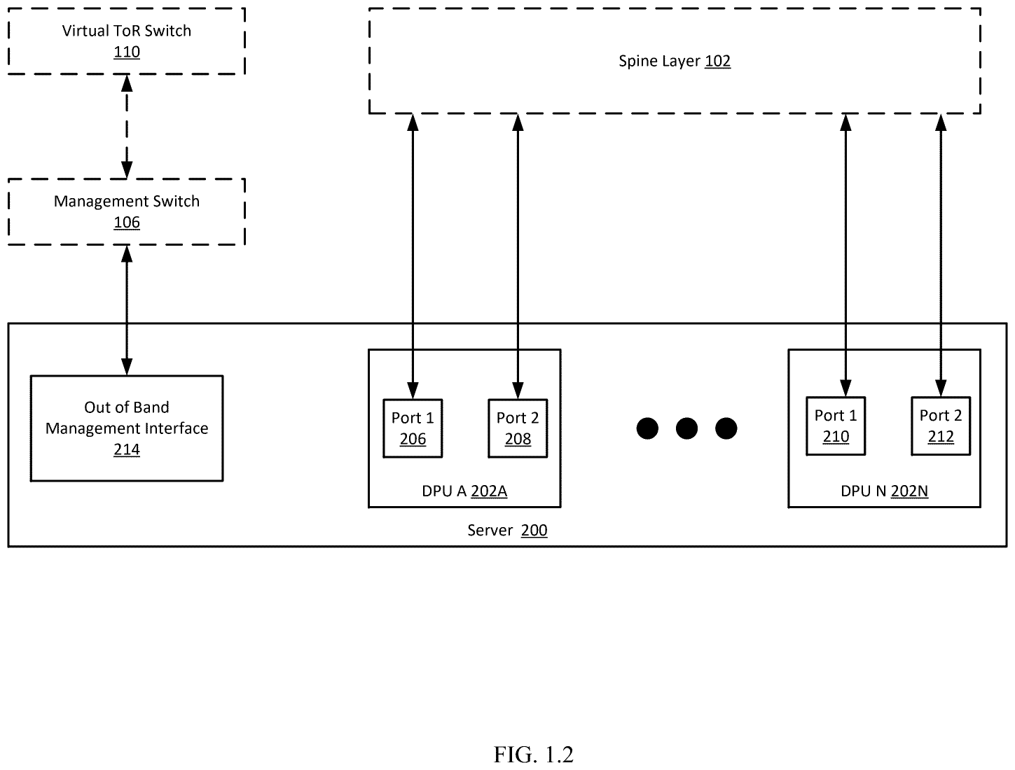

FIG. 1.1 shows a system in accordance with one or more embodiments of the invention. The system includes a super spine layer (100), a spine layer (102), a server layer (104), a management switch (106), and a management server (108). Each of these components is described below.

In one or more embodiments of the invention, the super spine layer (100) includes one or more super spine switches (100A, 100B). In one or more embodiments of the invention, the one or more super spine switches are physical devices that include persistent storage, memory (e.g., random access memory), one or more processor(s) and multiple physical ports. Each of the physical ports may or, may not be, connected to another device (e.g., a server, a switch, etc.). The super spine switch may be configured to receive packets via the ports and determine whether to drop the packet or process the packet, where processing the packet may include transmitting the packet to another device. In one or more embodiments of the invention, the super spine switches connect the servers (via the spine switches) to the Internet or another wide area network.

In one or more embodiments of the invention, the spine layer (102) includes one or more spine switches (102A, 102C). In one or more embodiments of the invention, the one or more spine switches are physical devices that include persistent storage, memory (e.g., random access memory), one or more processor(s) and multiple physical ports. Each of the physical ports may, or may not, be connected to another device (e.g., a server, a switch, etc.). The spine switches may be configured to receive packets via the ports and determine whether to drop the packet or process the packet, where processing the packet may include transmitting the packet to another device. In one or more embodiments of the invention, the spine switches connect the servers to the super spine switches. Typically, there are more spine switches than super spine switches.

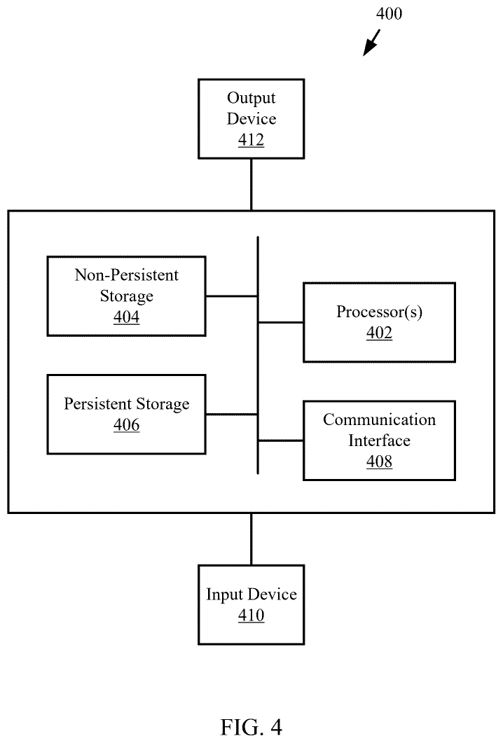

In one or more embodiments of the invention, the server layer (104) includes one or more servers (104A, 104D). In one or more embodiments of the invention, the server is a physical device, such as a computing system (e.g., 400, FIG. 4) as discussed below in more detail in FIG. 4, which may be used for performing various embodiments of the invention. The physical device may correspond to any other physical system with functionality to implement one or more embodiments of the invention. For example, the physical device may be a server (i.e., a device with at least one or more processor(s), memory, and an operating system, and one or more Data Processing Units (DPUs) (e.g., 202A, 202N)) that is directly connected to one or more spine switches in the spine layer (102). Each server in the server layer may be connected to one or more spine switches and to the management switch (106).

The servers in the server layer (104) are connected to the management switch (106) via an out-of-band (OOB) network. The OOB network is distinct from the network that includes the spine layer and the super spine layer. Said another way, the OOB network does not overlap with the network that includes the spine layer and the super spine layer. As such, the only way for the management switch (or the management server) to communicate with the spine layer or the super spine layer is via the server layer (104). In another embodiment of the invention, the servers in the server layer may be connected to the management switch using a virtual routing function (VRF) as opposed to an OOB.

Additional detail about the server layer is provided in FIG. 1.2.

In one or more embodiments of the invention, the management switch (106) is a switch. In one or more embodiments of the invention, the management switch is a physical device that includes persistent storage, memory (e.g., random access memory), one or more processor(s) and multiple physical ports. Each of the physical ports may or may not be connected to another device (e.g., a server, a switch, etc.). The management switch may be configured to receive packets via the ports and determine whether to drop the packet or process the packet, where processing the packet may include transmitting the packet to another device. In one or more embodiments of the invention, the management switches connects the servers to the management server (108).

In one or more embodiments of the invention, the management server (108) is a physical device, such as a computing system (e.g., 400, FIG. 4) as discussed below in more detail in FIG. 4, which may be used for performing various embodiments of the invention. The management server includes a virtual ToR switch (VTS) (110). The VTS operates in substantially the same manner as the super spine switch and the spine switch (as described above); however, the VTS is virtual as opposed to physical. Because the VTS is virtual, the VTS includes virtual interfaces as opposed to physical ports.

While the system in FIG. 1.1 has been illustrated and described as including a limited number of specific components, the system may include additional, fewer, and/or different components without departing from the scope of the embodiments disclosed herein. For example, the system may include multiple VTSes.

FIG. 1.2 shows a more detailed view of a portion of the system shown in FIG. 1.1 in accordance with one or more embodiments of the invention. More specifically, FIG. 1.2 provides additional detail of a server (200) in accordance with one or more embodiments of the invention.

In one or more embodiments, the servers (e.g., server (200)) in the server layer (e.g., 104 in FIG. 1.1) may include multiple DPUs (e.g., 202A, 202N). Each of the DPUs may be a dual-ported DPU (i.e., each of the DPUs includes two ports (e.g., 206, 208, 210, 212)). Those skilled in the art will appreciate that the DPUs are not limited to dual-ported DPUs.

In one or more embodiments of the invention, in addition to the ports (206, 208, 210, 212), each of the DPUs includes one or more specialized integrated circuits, volatile and non-volatile storage. In one or more embodiments of the invention, the specialized integrated circuit may be implemented using a Complex Instruction Set (CISC) Architecture or a Reduced Instruction Set (RISC) Architecture and may include multiple cores.

Using the aforementioned components, the DPU includes functionality to perform the operations and/or functions of a ToR switch. For example, the DPU includes functionality to process packets in the same or substantially the same manner as the switches described above (e.g., the super spine switch, the spine switch, and/or the management switch). Further, the DPU includes functionality to implement networking protocols (e.g., STP, OSPF, BGP, RIP, BDF, MPLS, PIM, ICMP, IGMP, etc.) in the same or substantially manner as the switches described above. In one or more embodiments of the invention, the DPUs and the VTS all execute the same network operating system (NOS). The NOS is a specialized operating system for network devices such as DPUs, switches, and virtual switches.

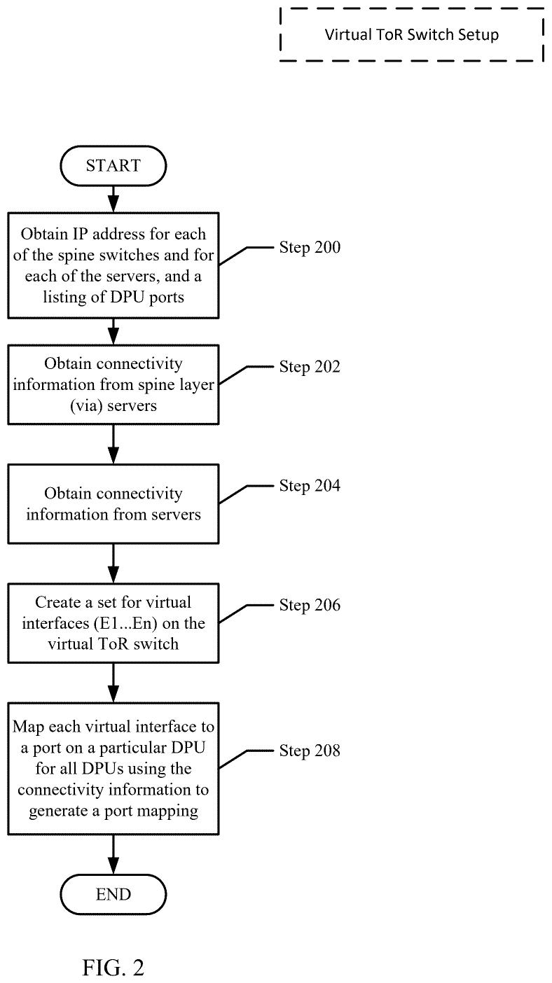

Continuing with the discussion of FIG. 2.1, each of the ports (208, 208, 210, 212) is directly connected to a physical port (not shown) on a spine switch (not shown) in the spine layer (102). Further, the server (200) includes at least one physical interface (e.g., OOB management interface (214)) that it uses to communicate with the VTS (110) via the management switch (106).

While the server in FIG. 1.2 has been illustrated and described as including a limited number of specific components, the system may include additional, fewer, and/or different components without departing from the scope of the embodiments disclosed herein.

FIG. 2 shows a method for configuring the system shown in FIG. 1.1 in accordance with one or more embodiments of the invention. All or a portion of the method shown in FIG. 2 may be performed by the virtual ToR Switch (VTS). Another component of the system may perform this method without departing from the invention. While the various steps in this flowchart are presented and described sequentially, one of ordinary skill in the relevant art will appreciate that some or all of the steps may be executed in different orders, may be combined or omitted, and some or all steps may be executed in parallel.

In Step 200, the following information is obtained: the IP addresses of the spine switches, the IP addresses for all the servers, the DPU ports (or more specifically, DPU port identifiers) on each of the servers. The IP addresses and DPU port identifiers may be directly obtained from a user (e.g., a network administrator). The IP addresses and DPU port identifiers may be obtained using any other mechanism or process without departing from the invention. At this stage, the VTS is aware of the servers, the DPU ports, and the spine switches. However, the VTS is unaware of how the DPU ports are connected to the ports on the spine switches.

In Step 202, connectivity information is obtained from the spine switches. The connectivity information may correspond to connectivity information that is generated using LLDP. Other protocols or mechanisms may be used to generate the connectivity information without departing from the invention. The connectivity information from the spine switches specifies what device (if any) is connected to each physical port in the spine switch. The connectivity information may be obtained from the spine switches by the VTS issuing (via the management switch) requests to one or more of the servers in the server layer. Upon receipt of the requests, the one or more servers obtains the requested information from the spine switches, e.g., from the local management information database (MIB) on each of the spine switches, and then provides the connectivity information (via the management switch) to the VTS.

In Step 204, connectivity information is obtained from the servers. The connectivity information may correspond to connectivity information that is generated using LLDP. Other protocols or mechanisms may be used to generate the connectivity information without departing from the invention. The connectivity information from the servers specifies what device (if any) is directly connected to each DPU port. The connectivity information may be obtained from the servers by the VTS issuing (via the management switch) requests to one or more of the servers in the server layer. Upon receipt of the requests, the one or more servers obtains the requested information, e.g., from the local management information database (MIB) on each of the servers, and then provides the connectivity information (via the management switch) to the VTS.

In Step 206, the VTS creates one more virtual interfaces. The VTS may create one virtual interface for each DPU port in the server layer.

In Step 208, the VTS using the IP addresses, the connectivity information from the spine switches, and the connectivity information from the servers to generate a port mapping. The port mapping specifies virtual interface to DPU port identifier mapping. In addition, in step 208, using the aforementioned information the VTS is also able to generate a network topology, which maps the virtual interfaces to a corresponding port on the spine switch.

After step 208, the VTS is aware of the physical connectivity between the DPU ports and the ports on the spine switches. Further, the VTS has a port mapping that maps virtual interfaces on the VTS to DPU ports.

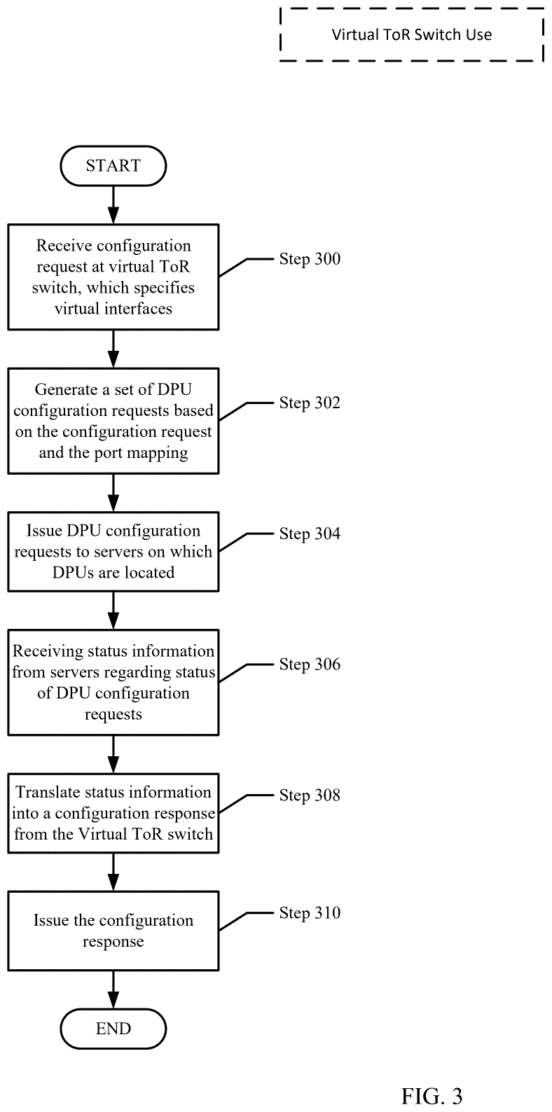

FIG. 3 shows a method for using the system shown in FIG. 1.1 in accordance with one or more embodiments of the invention. All or a portion of the method shown in FIG. 3 may be performed by the virtual ToR Switch (VTS). Another component of the system may perform this method without departing from the invention. While the various steps in this flowchart are presented and described sequentially, one of ordinary skill in the relevant art will appreciate that some or all of the steps may be executed in different orders, may be combined or omitted, and some or all steps may be executed in parallel.

In Step 300, a configuration request is received by the VTS, where the configuration request specifies a switch configuration command to be applied to one or more virtual interfaces. The configuration request may be obtained from a user (e.g., a network administrator). The switch configuration command may be any command that the user may issue to the VTS related to the management and/or operation of the VTS.

In Step 302, a set of DPU configuration requests (i.e., one or more DPU configuration requests) is generated based on the configuration request and the port mapping. In particular, the port mapping is used to identify the DPU ports corresponding to the virtual interfaces and to also identify the server on which the identified DPU ports are located. The DPU configuration request may correspond to an API call or other command that can be used to configure the DPU ports. Depending on the implementation of the DPUs, the DPUs may include representors (i.e., virtual interfaces), where each of the representors is mapped to one of the DPU ports. In this implementation, the DPU configuration requests specify the corresponding representors.

In Step 304, the DPU configuration requests are issued to each of the servers identified in step 302. The DPU configuration requests may be issued uses APIs and/or via another mechanism without departing from the invention.

In Step 306, status information is received from the servers (i.e., from the servers that received by the DPU configuration requests). The status information may specify that the DPU configuration request was successfully processed, the DPU configuration request failed, or may specify any other information.

In Step 308, the status information is translated (or otherwise converted) into a configuration response. The configuration response corresponds a response in a format that the user would expect to receive after submitting the configuration request in step 300. For example, if the user was using a command line interface (CLI) supported by the VTS, then the configuration response would be a response provided by the CLI. Said another way, even though the user is ultimately attempting to configure DPU ports in the servers, the user is issuing commands to configure virtual interfaces. Accordingly, the configuration response received by the user is that configuration requested for the virtual interfaces was successful or unsuccessful.

Continuing with the discussion of FIG. 3, in Step 310, the configuration response is issued to the user (e.g., displayed to the user).

FIG. 4 shows a computing system in accordance with one or more embodiments of the invention.

Embodiments of the invention may be implemented using computing devices. FIG. 4 shows a diagram of a computing device (400) in accordance with one or more embodiments. The computing device (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (408) (e.g., Bluetooth interface, infrared interface, network interface, optical interface, etc.), input devices (410), communication interface (408), and numerous other elements (not shown) and functionalities. Each of these components is described below.

In one or more embodiments, the computer processor(s) (402) may be an integrated circuit for processing instructions. For example, the computer processor(s) (402) may be one or more cores or micro-cores of a processor. The computing device (400) may also include one or more input devices (410), such as a touchscreen, keyboard, mouse, microphone, touchpad, electronic pen, or any other type of input device. The communication interface (408) may include an integrated circuit for connecting the computing device (400) to a network (not shown) (e.g., a local area network (LAN), a wide area network (WAN) such as the Internet, mobile network, or any other type of network) and/or to another device, such as another computing device.

In one or more embodiments, the computing device (400) may include one or more output devices (412), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) (410, 412) may be locally or remotely connected to the computer processor(s) (402), non-persistent storage (404), and persistent storage (406). Many diverse types of computing devices exist, and the aforementioned input and output device(s) (410, 412) may take other forms.

Specific embodiments are above described with reference to the accompanying figures. In the above description, numerous details are set forth as examples of the invention. One of ordinary skill in the art, having the benefit of this detailed description, would appreciate that one or more embodiments of the present invention may be practiced without these specific details and that numerous variations or modifications may be possible without departing from the scope of the invention. Certain details known to those of ordinary skill in the art may be omitted to avoid obscuring the description.

In the above description of the figures, any component described with regard to a figure, in various embodiments of the invention, may be equivalent to one or more like-named components shown and/or described with regard to any other figure. For brevity, descriptions of these components may not be repeated with regard to each figure. Thus, each and every embodiment of the components of each figure is incorporated by reference and assumed to be optionally present within every other figure having one or more like-named components. Additionally, in accordance with various embodiments of the invention, any description of any component of a figure is to be interpreted as an optional embodiment, which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the term ‘operatively connected’, or ‘operative connection’, means that there exists between elements/components/devices a direct or indirect connection that allows the elements to interact with one another in some way (e.g., via the exchange of information). For example, the phrase ‘operatively connected’ may refer to any direct (e.g., wired or wireless connection directly between two devices) or indirect (e.g., wired and/or wireless connections between any number of devices connecting the operatively connected devices) connection.

The problems discussed above should be understood as being examples of problems solved by embodiments of the invention and the invention should not be limited to solving the same/similar problems. The disclosed invention is broadly applicable to address a range of problems beyond those discussed herein.

While one or more embodiments have been described herein with respect to a limited number of embodiments and examples, those skilled in the art, having benefit of this invention, would appreciate that other embodiments can be devised which do not depart from the scope of the embodiments disclosed herein. Accordingly, the scope should be limited only by the attached claims.

What is claimed is:

1. A method for managing servers, comprising:
obtaining Internet Protocol (IP) addresses for each of a plurality of spine switches in a spine layer and for each of a plurality of servers in a server layer;
obtaining connectivity information for the spine layer;
obtaining connectivity information for a plurality of ports,
wherein each of the ports is a data processing unit (DPU) port,
wherein each of the ports is located on one of a plurality of DPUs in the server layer;
generating, by a virtual Top Of Rack (ToR) switch (VTS), a port mapping using the connectivity information for the spine layer, the connectivity information for the plurality of ports, and the IP addresses; and
configuring, using the VTS and the port mapping, the plurality of ports.

2. The method of claim 1, wherein each of the plurality of spine switches is physically connected to at least one of the plurality of ports.

3. The method of claim 1, wherein the VTS is executing on a management server that is operatively connected to the server layer.

4. The method of claim 3, wherein the management server is operatively connected to the server layer using a management switch, wherein the management switch is connected to each of the plurality of servers in the server layer via an out-of-band (OOB) management network.

5. The method of claim 3, wherein the management server is not directly connected to the spine layer.

6. The method of claim 1, wherein the connectivity information for the spine layer is determined using link layer discovery protocol (LLDP).

7. The method of claim 1, wherein the connectivity information for the plurality of ports is determined using link layer discovery protocol (LLDP).

8. The method of claim 1, wherein the VTS comprises a plurality of virtual interfaces, wherein the port mapping associates each of the plurality of virtual interfaces to one of the plurality of ports.

9. The method of claim 8, wherein configuring the server layer comprises configuring at least one of the plurality of ports.

10. The method of claim 8, wherein configuring the server layer comprises:
obtaining, from a user, a configuration request specifying a virtual interface of the plurality of virtual interfaces;
generating, based on the configuration request and the port mapping, a DPU configuration request specifying a port of the plurality of ports that corresponds to the virtual interface; and
issuing the DPU configuration request to a server of the plurality of servers, wherein the server comprises the port.

11. The method of claim 10, wherein configuring the server layer further comprises:
after issuing the DPU configuration request, receiving status information from the server, wherein the status information specifies the port;
translating the status information into a configuration response, wherein the configuration response specifies the virtual interface; and
issuing the configuration response to the user.

12. A non-transitory computer readable medium (CRM) comprising instructions that, when executed by a processor on a management server, perform a method, the method comprising:
obtaining Internet Protocol (IP) addresses for each of a plurality of spine switches in a spine layer and for each of a plurality of servers in a server layer,
obtaining connectivity information for the spine layer;
obtaining connectivity information for a plurality of ports,
wherein each of the ports is a data processing unit (DPU) port,
wherein each of the ports is located on one of a plurality of DPUs in the server layer, generating, by a virtual Top Of Rack (ToR) switch (VTS) executing on the management server, a port mapping using the connectivity information for the spine layer, the connectivity information for the plurality of ports, and the IP addresses; and
configuring, using the VTS and the port mapping, the plurality of ports.

13. The CRM of claim 12, wherein each of the plurality of spine switches is physically connected to at least one of the plurality of ports.

14. The CRM of claim 13, wherein the management server is operatively connected to the server layer using a management switch, wherein the management switch is connected to each of the plurality of servers in the server layer via a virtual routing function.

15. The CRM of claim 12, wherein the management server is not directly connected to the spine layer.

16. The method of claim 12, wherein the connectivity information for the spine layer is determined using link layer discovery protocol (LLDP) and wherein the connectivity information for the plurality of ports is determined using the LLDP.

17. The CRM of claim 12, wherein the VTS comprises a plurality of virtual interfaces, wherein the port mapping associates each of the plurality of virtual interfaces to one of the plurality of ports.

18. The CRM of claim 17, wherein configuring the server layer comprises configuring at least one of the plurality of ports.

19. The CRM of claim 17, wherein configuring the server layer comprises:
obtaining, from a user, a configuration request specifying a virtual interface of the plurality of virtual interfaces;
generating, based on the configuration request and the port mapping, a DPU configuration request specifying a port of the plurality of ports that corresponds to the virtual interface;
issuing the DPU configuration request to a server of the plurality of servers, wherein the server comprises the port;
after issuing the DPU configuration request, receiving status information from the server, wherein the status information specifies the port;
translating the status information into a configuration response, wherein the configuration response specifies the virtual interface; and
issuing the configuration response to the user.

20. A method for managing servers, comprising:
obtaining connectivity information for a plurality of ports and the plurality of switches,
wherein each of the ports is a data processing unit (DPU) port, and
wherein each of the ports is located on one of a plurality of DPUs on one of a plurality of servers;
generating, by a virtual Top Of Rack (ToR) switch (VTS) executing on a management server, a port mapping using the connectivity information,
wherein the management server is not directly connected to the plurality of switches; and
configuring, using the VTS and the port mapping, a port of the plurality of ports.
